(19) United States
(12) Patent Application Publication
(10) Pub. No.: US 2015/0218753 A1
(43) Pub. Date: Aug. 6, 2015

(54) Sealing device and roller having a sealing device

(71) Applicant: VOITH PATENT GMBH, HEIDENHEIM (DE)

(72) Inventors: Marc Erkelenz, Ulm (DE); Jochen Honold, Schlingen (DE)

(21) Appl. No.: 14/422,034

(22) PCT Filed: Aug. 5, 2013
(86) PCT No.: PCT/EP2013/066376

§ 371 Date: Feb. 17, 2015

(30) Foreign Application Priority Data
Aug. 15, 2012 (DE) 10 2012 214 536.2

(51) Int. Cl. D21F 3/10; D21F 7/00; F16J 15/16

(52) U.S. Cl. CPC D21F 3/10; F16J 15/162; D21F 7/00

(57) ABSTRACT

A sealing device seals a pressure or vacuum zone in a roller with a perforated roller sleeve that rotates relative to the sealing device. A sealing strip and a format limiter seal the pressure or vacuum zone. The sealing strip has a lubricant opening formed as an upwardly open depression. A sealing face of the sealing strip and of the format limiter brace against the roller sleeve, and the roller sleeve runs onto the sealing strip at the front end and runs off the sealing strip at the rear end. A lubricant opening of a second type which is open toward the upper side, but not toward the end side against which the format limiter is placed, and/or a lubricant opening of a third type is upwardly open and toward that end side against which the format limiter is placed, and/or at least in portions no lubricant opening is provided.

The invention relates to a sealing device according to the preamble of patent claim 1, and to a roller having a sealing device according to the preamble of patent claim 15, in particular for use in a machine for manufacturing and/or processing a fibrous web, such as a paper web, cardboard web or tissue web.

Suction rollers are used at various points in a machine manufacturing or processing a fibrous web. In this manner, suction rollers are used as doffing rollers, for example, for transferring the fibrous web from one machine section to another machine section. Suction rollers furthermore are used in the drying section of such a machine.

When the invention is described in the following by means of a suction roller, the comments made in the context of the invention should apply in equal measure to a blower roller, without specific mention being made thereof in each case.

Suction rollers possess one or more negative-pressure zones which are in each case sealed in relation to the environment by means of a sealing device. The sealing device here displays a sealing strip which is placed against the inner side of the roller sleeve for sealing the negative-pressure zone On account of the frictional contact between the inner side and the sealing face, wear of the sealing strip in the region of the sealing face occurs, which in turn noticeably reduces the service life of such sealing strips. In order to reduce wear, it is proposed in the prior art to introduce a lubricant, such as water, between the sealing face and the inner side of the roller sleeve. To this end, it has been proposed in the past to introduce lubricant between the sealing face and the inner side of the roller sleeve by means of injection pipes which, in the rotation direction of the roller sleeve, are disposed upstream of the first sealing strip. This method has proven very expensive and ineffective, since a lot of lubricant has to be used, on the one hand, and the lubricating effect is insufficient, in particular for the sealing strips which, in the rotation direction, are downstream. For this reason, the applicant has developed a new sealing device which is the subject matter of a plurality of patent applications and by means of which, in the form of a lubricant channel which is disposed in the region of the sealing face, the supply of lubricant is an integral part of the sealing strip, by means of which lubricant channel the lubricant can be delivered directly between the sealing face and the inner side of the roller sleeve. It has now emerged that suction rollers or blower rollers which in the width of their positive-pressure or negative-pressure zone are delimited by format limiters may draw or blow leak air which may escape laterally through the lubricant channel.

The object of the present invention is thus to further improve the sealing device and roller, which are improved with respect to lubricating efficiency, in such a manner that said sealing device and roller are also employable for suction rollers or blower rollers having a format limiter.

According to a first aspect, the object is achieved by a sealing device for sealing a positive-pressure or negative-pressure zone in a roller which comprises a perforated roller sleeve which is rotatable in relation to the sealing device of a paper-, cardboard-, tissue, or non-woven fabric making machine, wherein the sealing device has at least one sealing strip for sealing the front-side or rear-side of the positive-pressure or negative-pressure zone, when viewed in the rotation direction of the roller, and at least one format limiter for sealing a peripheral end of the positive-pressure or negative-pressure zone, when viewed in the longitudinal direction of the roller and the sealing strip. At least one of the at least one sealing strip here has a front and a rear end side which delimit the sealing strip in its width, and an upper and a lower side. The upper side here provides a sealing face, and the sealing strip, when viewed in its longitudinal direction, has two peripheral regions and a central region disposed therebetween. Furthermore, the sealing strip in the central region provides at least one lubricant opening of the first type, which is formed by a depression in the material of the sealing strip and is open at least toward the upper side, and at least one of the at least one format limiter is disposed so as to be level with one of the two peripheral regions, when viewed in the longitudinal direction of the sealing strip. The format limiter has a sealing face and an end side, which is placed against that end side of the sealing strip that faces toward the positive-pressure or negative-pressure zone. In the case of the installation of the sealing device according to the intended use into the roller the sealing face of the sealing strip and the format limiter are placed against the inner side of the roller sleeve. Furthermore, the roller sleeve, while turning, runs onto the sealing strip at the front end side thereof, and runs off the sealing strip again at the rear end side thereof.

The sealing device according to the invention is characterized in that, at least in the peripheral region in which the end side of the format limiter is placed against the end side of the sealing strip,

i) the sealing strip has at least one lubricant opening of the second type which is open toward the upper side, which is not open toward the end side of the sealing strip against which the end side of the format limiter is placed, and/or

ii) the sealing strip is provided with at least one lubricant opening of the third type, which is open toward the upper side, which is additionally open toward that end side of the sealing strip against which the end side of the format limiter is placed, wherein the extent of the lubricant opening of the third type, when viewed in the longitudinal direction of the sealing strip, is the same as or smaller than the extent of the format limiter, and/or

iii) the sealing strip at least in portions has no lubricant opening.

The sealing strip of the invention according to the preamble, in its central region, has at least one lubricant opening which is open at least toward the upper side. Since the upper side of the sealing strip comprises the sealing face which, in the intended use, is placed against the inner side of the roller sleeve, on account thereof, lubricant may be directly and also effectively introduced between the sealing face and the inner side of the roller sleeve.

In order to be able to effectively seal the peripheral region, it is necessary that no leak air can be suctioned or blown between the format limiter which seals the positive-pressure or negative-pressure zone and which is disposed in the peripheral region and with its end side is placed against one of the end sides of the sealing strip in its peripheral region. To this end it is important that the contact region in which the two end sides overlap is not interrupted by any lubricant opening in such a manner that leak air can makes its way therethrough.

According to a first variant of the solution according to the invention, according to the feature of patent claim 1, to this end a lubricant opening of the second type, which is open toward the upper side of the sealing strip and thus ensures lubrication of the sealing strip in the peripheral region, but is not open toward that end side of the sealing strip that, with the end side of the format limiter, forms the contact region, is proposed, on account of which it is ensured that the contact region between the end side of the format limiter and the sealing strip, in the case of the installation of the sealing device according to the intended use into the roller, when viewed in the direction of the height of the sealing device, extends in an uninterrupted manner up to the two sealing faces of the sealing strip and the format limiter which are placed against the inner side of the roller sleeve.

Alternatively or additionally to the first variant, according to a second variant of the solution according to the feature of patent claim 1, in the peripheral region at least one lubricant opening of the third type, which is open toward the upper side and also the end side of the sealing strip and against which the end side of the format limiter is placed, is proposed. On account thereof it can be achieved that the lubricant opening of the sealing face can be disposed upstream in the rotation direction of the roller sleeve and on account thereof the lubricant can be delivered directly in front of the sealing face, between the inner side of the roller sleeve and the sealing face. In order to nevertheless achieve an uninterrupted extent of the contact region between the two end sides up to the two sealing faces of the sealing strip and the format limiter, it is proposed that the longitudinal extent of the opening of the lubricant opening of the third type in the end side is smaller than or at maximum the same as the longitudinal extent of the format limiter.

According to the additional or alternative third variant of the solution according to the invention it is also proposed according to the feature of patent claim 1 that in the peripheral region at least in portions no lubricant opening is provided. Here, certain portions of the peripheral region are not lubricated which is tolerable if said portions of the peripheral region do not have too great an extent in the longitudinal direction of the sealing strip. Furthermore, on account thereof, an uninterrupted extent of the contact region formed between the end side of the sealing strip and the end side of the format limiter can be achieved, on account of which no leak air can pass through between the two end sides.

Advantageous design embodiments and refinements of the invention are stated in the dependent claims.

It should be noted at this point that the longitudinal direction of the roller and the longitudinal direction of the sealing strip coincide with one another. When thus mention is made in the following of the longitudinal direction of the roller, the longitudinal direction of the sealing strip is to be likewise understood thereby and vice-versa.

Where the at least one peripheral region comprises both a lubricant opening of the second and the third type, the latter preferably are separated from one another by a portion without a lubricant opening, i.e. they are not interconnected.

Where the at least one peripheral region comprises a plurality of lubricant openings of the third type which in the longitudinal direction of the sealing strip are disposed behind one another, lubricant openings of the third type which are in each case mutually adjacent preferably are separated from one another by a portion without a lubricant opening, i.e. they are not interconnected.

It is also conceivable for a lubricant opening of the second and/or third type disposed in a peripheral region to be separated from a lubricant opening of the first type which is disposed in the central region by a portion without a lubricant opening, i.e. for them not to be interconnected.

However, it is also conceivable for a lubricant opening of the second type to be connected to a lubricant opening of the first type by way of a portion having a lubricant opening which substantially extends in the direction of the width of the sealing strip.

According to a preferred design embodiment it is provided that the format limiter in the peripheral region is displaceable at least in portions in the longitudinal direction of the sealing strip. It is also conceivable for the format limiter in the peripheral region to not be displaceable in the longitudinal direction of the sealing strip.

According to a further design embodiment of the invention it is provided for a first format limiter which is displaceable in the longitudinal direction of the roller and for a second format limiter which is non-displaceable in the longitudinal direction of the roller to be disposed in the peripheral region. It is particularly conceivable here that the first format limiter is disposed so as to be closer to that roller end that closes off the peripheral region than the second format limiter. Where the second and the first format limiter are disposed in the peripheral region it is particularly conceivable that the second format limiter, when viewed in the longitudinal direction of the roller, seals an inner positive-pressure or negative-pressure zone, and the first displaceable format limiter seals an outer positive-pressure or negative-pressure zone which is further outboard and which, when viewed in the longitudinal direction of the roller, adjoins the inner positive-pressure or negative-pressure zone and has a lower positive pressure or negative pressure than the inner positive-pressure or negative-pressure zone.

It is furthermore conceivable that, when viewed in the longitudinal direction of the roller and sealing strip, in each case at least one format limiter is disposed so as to be level with the respective peripheral region of the sealing strip on both peripheral ends of the positive-pressure or negative-pressure zone.

It is conceivable that the sealing device, when viewed in the rotation direction of the roller, has a front sealing strip which is disposed ahead of the positive-pressure or negative-pressure zone, and a rear sealing strip which is disposed behind the positive-pressure or negative-pressure zone, and that the format limiter extends between the front and rear sealing strip. In this case, the format limiter may have a front end side which is placed against the rear end side of the front sealing strip, and a rear end side which is placed against the front end side of the rear sealing strip. In this case, preferably at least the rearward of the sealing strips is a sealing strip which in the central region has at least one lubricant opening of the first type and in at least a peripheral region has at least in portions no lubricant opening and/or has a lubricant opening of the second and/or third type.

Preferably, the upper side is formed by the sealing face.

The lubricant may be water, for example.

A specific design embodiment of the first variant of the sealing device according to the invention may provide, for example, that the lubricant opening of the second and/or third type, when viewed in the direction of the width of the sealing strip, extends between a front portion of the sealing face which adjoins the front end side and a rear portion of the sealing face which adjoins the rear end side. In this case, the lubricant opening, when viewed in the direction of the width of the sealing strip, is thus surrounded by the sealing face of the sealing strip, wherein in this case substantially only the rear portion of the sealing face, which, in the rotation direction of the roller sleeve, is disposed behind the lubricant opening, is supplied with the lubricant.

A further specific design embodiment of the invention provides that the lubricant opening of the first and/or third type, when viewed in the direction of the width of the sealing strip, extends between the front end side and the sealing face. Since the roller sleeve, while turning, runs onto the sealing strip on the latter's end face, then, with the inner side of said roller sleeve, runs over the sealing face, and then runs off the sealing strip again at the rear end side thereof, it is achieved on account thereof that the sealing face is supplied with the lubricant before said sealing face comes into contact with the inner side of the roller sleeve. This embodiment may be specifically implemented such that, when viewed in the direction of the width of the sealing strip, the lubricant opening of the first and/or third type extends from the front end side to the sealing face and the sealing face extends from the lubricant opening of the first and/or third type to the rear end side.

According to a further particularly preferred embodiment of the invention, the lubricant opening of the first and/or second and/or third type preferably are/is configured as a lubricant channel in the form of a groove-type depression in the material of the sealing strip, which substantially extends in the longitudinal direction of the sealing strip. The lubricant opening of the first type which is configured as a lubricant channel—in the following referred to as the first lubricant channel—, when viewed in the longitudinal direction of the sealing strip, preferably has a larger extent than the lubricant opening of the second type, in particular than the lubricant opening of the second type configured as a lubricant channel—in the following referred to as the second lubricant channel—and/or than the lubricant opening of the third type, in particular than the lubricant opening of the third type configured as a lubricant channel—in the following referred to as the third lubricant channel.

In particular, the first lubricant channel extends substantially across the length of the central region; it is conceivable, for example, for the first lubricant channel to extend across at least 90% of the length of the central region. It is furthermore conceivable for the second lubricant channel to extend substantially across the length of the respective peripheral region, in particular for the second lubricant channel to extend across at least 90% of the length of the peripheral region.

Since a format limiter, when viewed in the longitudinal direction of the sealing strip, has an extent of 15 cm or less, often of 6 cm to 3 cm or less, it is particularly conceivable for the extent of the at least one lubricant opening of the third type, when viewed in the longitudinal direction of the sealing strip, to be 10 cm or less, preferably 5 cm or less. In order to obtain a sufficient overlapping region, it may be particularly meaningful for the extent of the lubricant opening of the third type, when viewed in the longitudinal direction of the sealing strip, to correspond to 50% to 80% of the extent of the format slide, when viewed in the longitudinal direction of the sealing strip. In order to ensure good lubrication across the extent of the at least one peripheral region, in the event of it being implemented with lubricant openings of the third type, it is in particular provided that, when viewed in the longitudinal direction of the sealing strip, a plurality of lubricant openings are disposed behind one another in the peripheral region, wherein in each case one portion without a lubricant opening runs between adjacent third lubricant openings.

It is furthermore to be noted that the sealing face of the sealing strip in the longitudinal direction may have an extent (corresponds to the machine cross direction in the case of the installation according to the intended use of said sealing strip) of 2 meters to 11 meters and more, and in the direction of the width of said sealing strip (corresponds to the machine direction in the case of the installation according to the intended use of said sealing strip) of 1 cm to 30 cm. The sealing face of the format limiter in the machine direction may have an extent of 10 cm to 150 cm, and in the machine cross direction the abovementioned extent of 15 cm or less, often of 6 cm to 3 cm or less.

A further preferred design embodiment of the invention provides that the lubricant opening of the first and/or third type, when viewed in a plane which is perpendicular to the longitudinal direction of the sealing strip, has a base and a front and rear side wall, wherein the front side wall extends from the base to the front end side, and the rear side wall extends from the base to the sealing face of the sealing strip, and wherein the front end side and the front side wall, when viewed in the direction of the height of the sealing strip, do not extend up to the sealing face of the sealing strip.

It is particularly conceivable in this context for the rear wall to enclose an angle of 1° to 89°, in particular of 15° to 75°, with a horizontal. On account thereof, it is achieved that the lubricant is pushed by the air which is entrained by the roller sleeve out of the respective channel into the gap which is formed between the sealing face and the inner side of the roller sleeve, on account of which lubrication efficiency is further increased.

According to a second independent aspect of the invention, a roller for a machine for manufacturing or processing a fibrous web is proposed, wherein the roller comprises a moveable perforated roller sleeve and a positive-pressure or negative-pressure zone which is disposed within the roller sleeve and is rotationally fixed in comparison with the roller sleeve, and which in relation to the environment is sealed by means of a sealing device as claimed in at least one of claims 1 to 14.

According to a further independent third aspect of the invention, a sealing strip having the following features is proposed:

The sealing strip is suitable for use in a sealing device for sealing a positive-pressure or negative-pressure zone in a roller of a paper-, cardboard-, tissue-, or non-woven fabric making machine, which comprises a perforated roller sleeve which is rotatable in relation to the sealing device.

The sealing strip has a front and a rear end side, which delimit the sealing strip in its width, and an upper and a lower side. Here, the upper side provides a sealing face which, in the case of the installation of the sealing strip according to the intended use into the sealing device, is placeable against the inner side of the roller sleeve for sealing the positive-pressure or negative-pressure zone. The sealing strip, when viewed in the longitudinal direction of the former, has two peripheral regions and a central region which is disposed therebetween. Furthermore, the sealing strip in the central region provides at least one lubricant opening of the first type which is formed by a depression in the material of the sealing strip and is at least open toward the upper side.

The sealing strip, in the case of the installation in the sealing device according to the intended use, furthermore is suitable for interaction with a format limiter for sealing a peripheral end of the positive-pressure or negative-pressure zone, when viewed in the longitudinal direction of the sealing strip, in so far as said format limiter, when viewed in the longitudinal direction of the sealing strip, is disposed so as to be level with one of the two peripheral regions of the sealing strip and has an end side, which is placed against that end side of the sealing strip that faces toward the positive-pressure or negative-pressure zone, and has a sealing face which is placeable against the inner side of the roller sleeve for sealing the positive-pressure or negative pressure zone. In the case of the installation of the sealing strip into the sealing device of the roller according to the intended use, the roller sleeve, while turning, furthermore runs onto the sealing strip on the front end side thereof and runs off the sealing strip again on the rear end side thereof.

The sealing strip according to the invention is characterized in that, at least in the peripheral region in which the end side of format limiter in the case of the installation into the sealing device of the roller according to the intended use is placed against the end side of said sealing strip,

i) the sealing strip has at least one lubricant opening of the second type which is open toward the upper side, but which is not open toward that end side of the sealing strip onto which the end side of the format limiter is placed and/or

ii) at least one lubricant opening of the third type, which is open toward the upper side, which is additionally open toward that end side of the sealing strip against which the end side of the format limiter is placed, is provided, wherein the extent of the lubricant opening of the third type, when viewed in the longitudinal direction of the sealing strip, is the same as or smaller than the extent of the format limiter and/or

iii) at least in portions no lubricant opening is provided.

The sealing strip here may be configured so as to be identical to the sealing strip described in claims 1 to 14 and the associated description of the sealing device protected in these claims. That is to say that all advantageous design embodiments and refinements of the sealing device according to the invention which refer to the features of the sealing strip also correspond to advantageous design embodiments and refinements of the sealing strip according to the invention.

The invention is explained in more detail by means of schematic figures which are not to scale. In the figures:

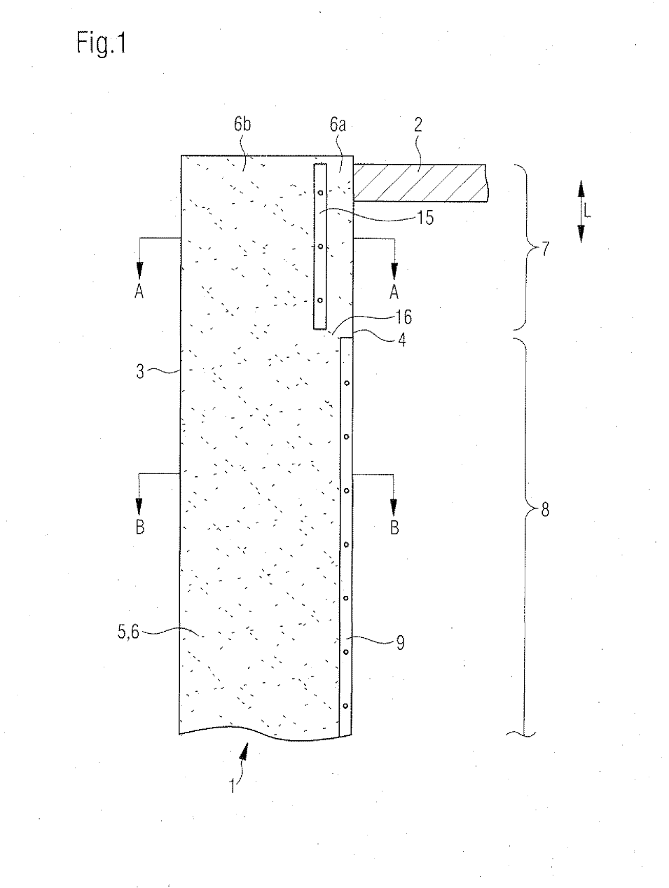

FIG. 1 shows a first embodiment of a sealing strip of a sealing device according to the invention, in a plan view,

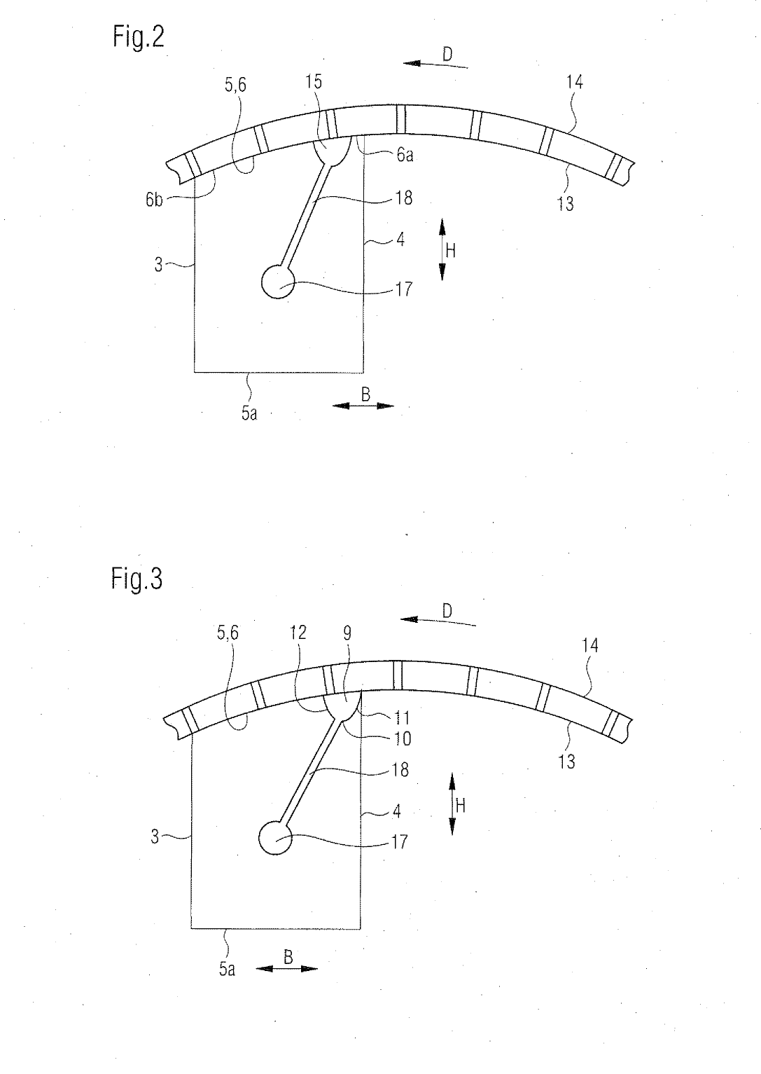

FIG. 2 shows the sealing strip of FIG. 1 in a sectional plane A-A which runs perpendicularly to the longitudinal axis of the sealing strip,

FIG. 3 shows the sealing strip of FIG. 1 in a sectional plane B-B which runs perpendicularly to the longitudinal axis of the sealing strip,

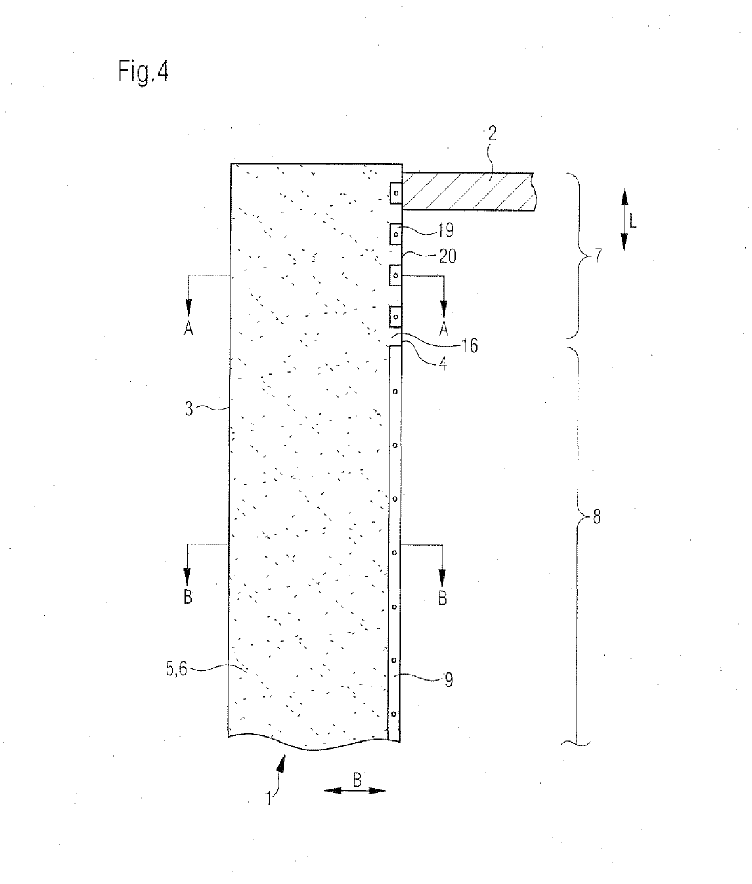

FIG. 4 shows a second embodiment of a sealing strip of a sealing device according to the invention, in a plan view,

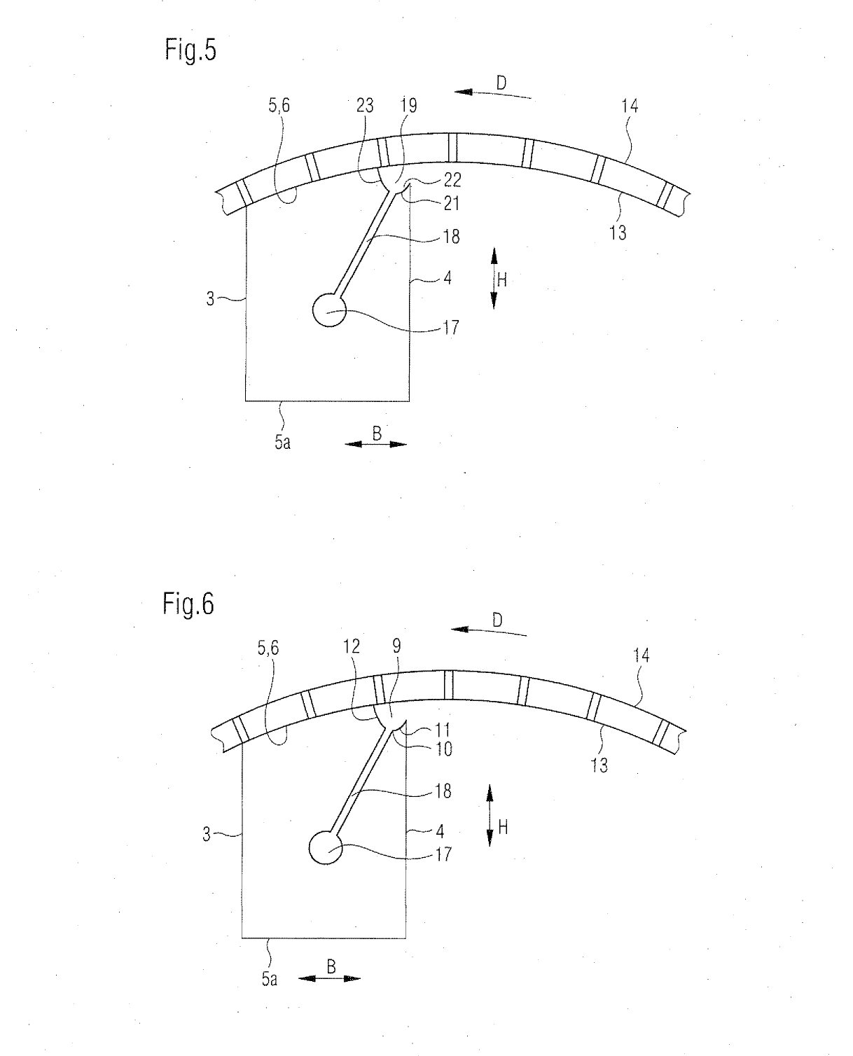

FIG. 5 shows the sealing strip of FIG. 4 in a sectional plane A-A which runs perpendicularly to the longitudinal axis of the sealing strip,

FIG. 6 shows the sealing strip of FIG. 4 in a sectional plane B-B which runs perpendicularly to the longitudinal axis of the sealing strip,

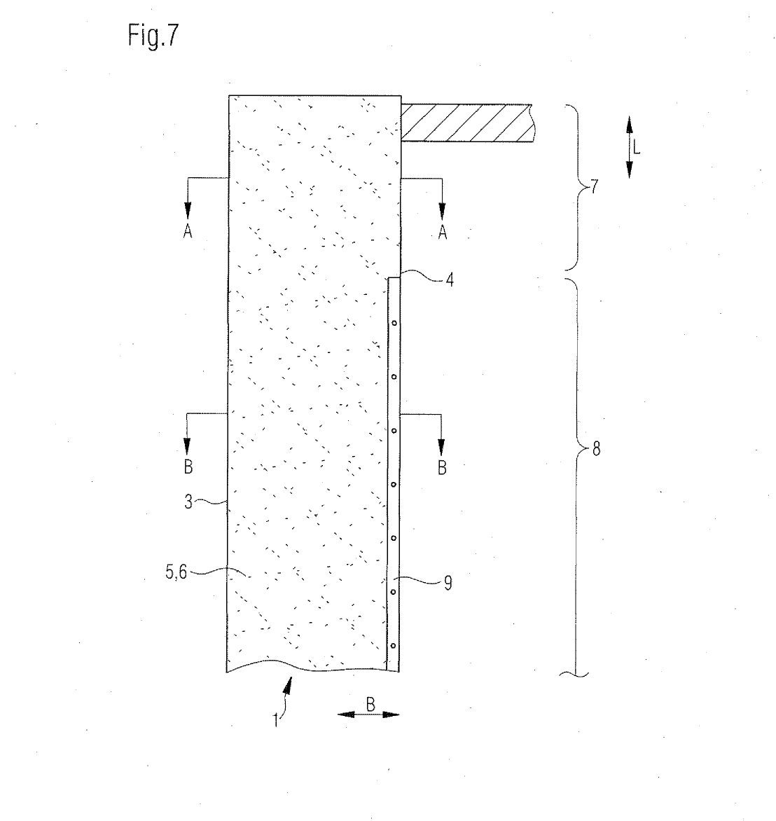

FIG. 7 shows a third embodiment of a sealing strip of a sealing device according to the invention, in a plan view,

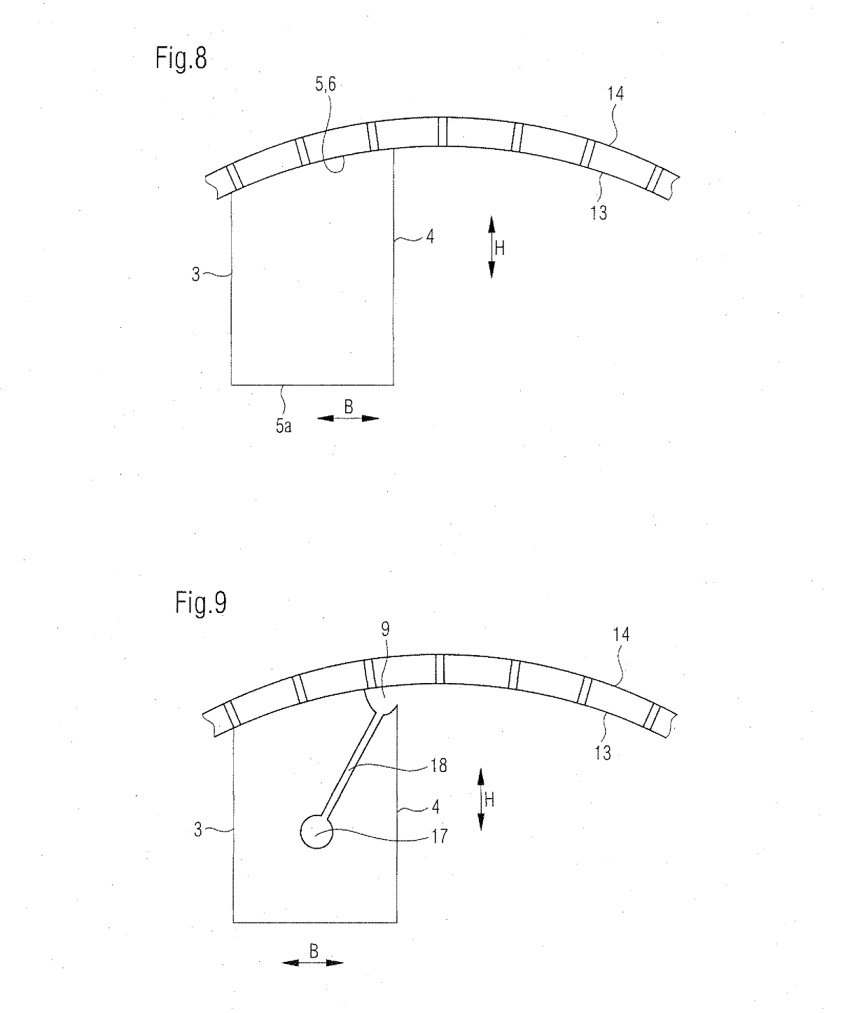

FIG. 8 shows the sealing strip of FIG. 7 in a sectional plane A-A which runs perpendicularly to the longitudinal axis of the sealing strip,

FIG. 9 shows the sealing strip of FIG. 7 in a sectional plane B-B which runs perpendicularly to the longitudinal axis of the sealing strip,

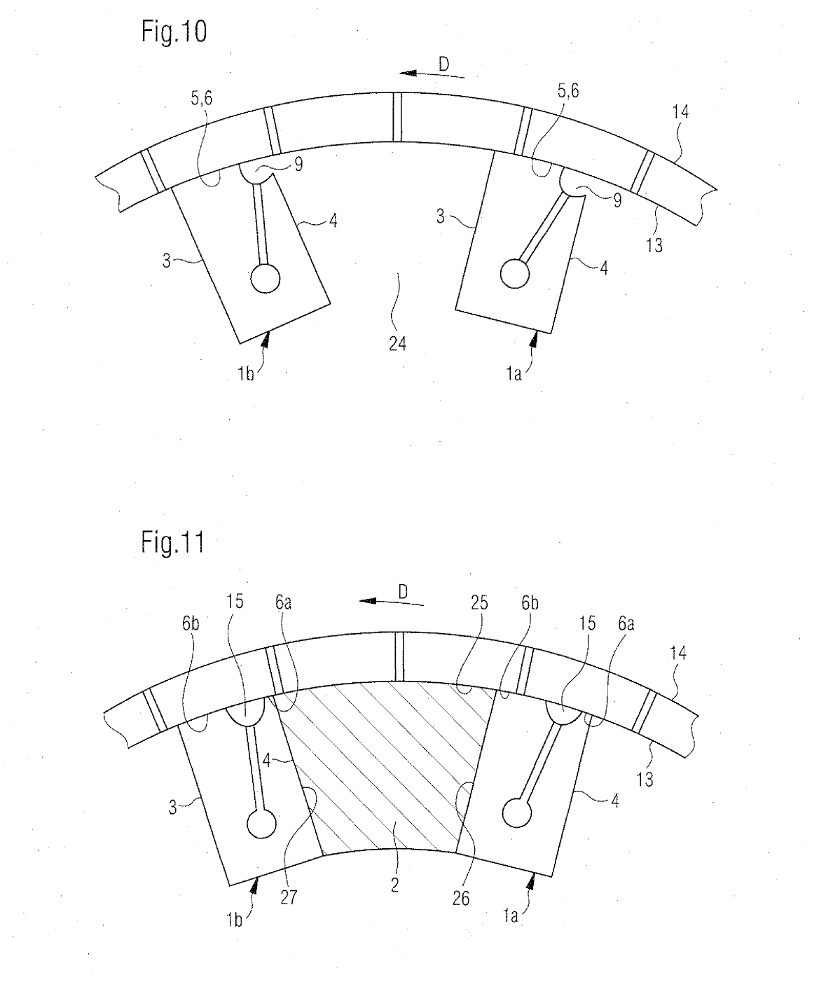

FIG. 10 shows a roller according to the invention, having a sealing device according to the invention, having two sealing strips according to the first embodiment as shown in FIGS. 1 to 3, in the sectional plane B-B,

FIG. 11 shows the roller according to the invention, having the sealing device according to the invention, having two sealing strips according to the first embodiment as shown in FIGS. 1 to 3, in the sectional plane A-A, and

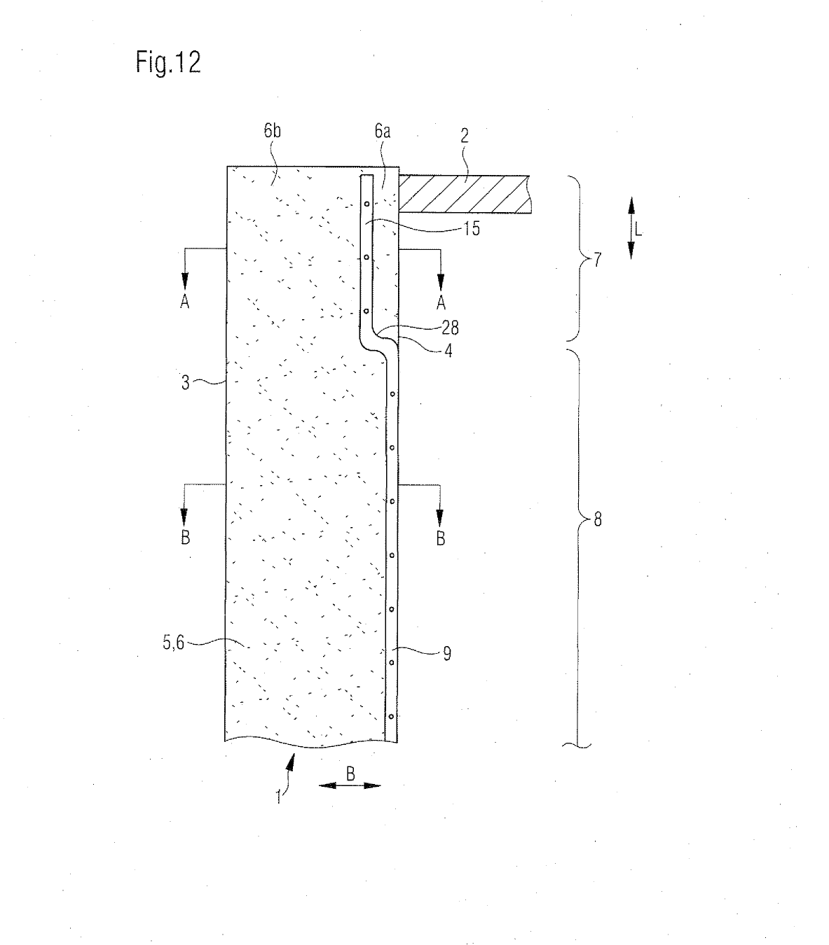

FIG. 12 shows a fourth embodiment of a sealing strip of a sealing device according to the invention, in a plan view.

FIGS. 1 to 3 show a first embodiment of a sealing strip 1 of a sealing device according to the invention, comprising the sealing strip 1 and a format limiter 2, in a plan view (FIG. 1), and in FIGS. 2 and 3, the sealing strip 1 shown in FIG. 1, interacting with a perforated roller sleeve rotating in the rotation direction D, in two sectional planes A-A and B-B which extend perpendicularly to the longitudinal direction L of the sealing strip.

The sealing strip 1, when viewed in its longitudinal direction L, is only illustrated in portions. The sealing strip 1 has a front end side 4 and a rear end side 3 lying opposite thereto, by way of which the sealing strip 1 is delimited in its width. The sealing strip 1 furthermore has an upper side 5 and a lower side 5a which delimit the sealing strip in its height, wherein in the present exemplary embodiment the upper side 5 provides a sealing face 6 which is drawn in a punctiform manner and forms the upper side 5. The sealing strip 1, when viewed in its longitudinal direction L, has two peripheral regions 7, of which presently one peripheral region 7 is visible, and a central region 8 disposed therebetween, which presently is shown only in portions. The format limiter 2 is presently displaceable in the longitudinal direction L of the sealing strip 1 in the peripheral region 7.

In the central region 8, the shown sealing strip 1 has a lubricant opening of the first type, which is formed by a depression and is open toward the upper side 5 and to the front side 4, and which presently is configured as a lubricant channel 9 in the form of a groove-type depression in the material of the sealing strip 1, extending in its longitudinal direction in the longitudinal direction L of the sealing strip 1, through which, in the case of the installation of the sealing strip into a roller according to the intended use, lubricant is deliverable between the inner side 13 of the roller sleeve 14 and the sealing face 6.

The first lubricant channel 9, in its longitudinal direction, extends on substantially the entire length of the central region 8. The first lubricant channel 9, when viewed in the direction of the width of the sealing strip 1, is disposed between the front end side 4 and the sealing face 6. As can be derived from the illustration of FIG. 3, the first lubricant channel 9 has a base 10 and a front side wall 11 and a rear side wall 12, wherein the front side wall 11 extends from the base 10 to the front end side 4, and the rear side wall 12 extends from the base 10 to the sealing face 6 of the sealing strip 1, and wherein the front end side 4 and the front side wall 11, when viewed in the direction of the height H of the sealing strip 1, do not extend up to the sealing face 6 of the sealing strip 1. On account thereof, in the case of the installation of the sealing device into the roller according to the intended use, a gap is formed between the front end side 4 and the inner side 13 of a roller sleeve 14, which gap tapers off toward the sealing face 6.

In the peripheral region 7, the sealing strip 1 according to the invention has a lubricant opening of the second type, which is open toward the upper side 5, but not toward the front end side 4, against which the format limiter 2 with its end side is placed. The lubricant opening of the second type 15 is presently configured as a second lubricant channel 15 in the form of a groove-type depression in the material of the sealing strip 1. The second lubricant channel 15, in its longitudinal direction, extends in the longitudinal direction L of the sealing strip 1, specifically substantially across the entire length of the peripheral portion 7. As can be derived from FIG. 2, the second lubricant channel 15, in the direction of the width B, extends between a front portion 6a of the sealing face 6, which adjoins the front end side 4, and a rear portion 6b of the sealing face 6, which adjoins the rear end side 3. In other words, the sealing face 6 in the peripheral region 7 is subdivided by the second lubricant channel 15 into a front portion 6a and a rear portion 6b.

It is to be noted that the first lubricant channel 9, in the longitudinal direction L of the sealing strip 1, has a larger extent than the second lubricant channel 15.

A small portion 16 in which no lubricant opening runs is disposed between the first lubricant channel 9 and the second lubricant channel 15, when viewed in the longitudinal direction L of the sealing strip 1.

Both lubricant channels 9, 15 are connected to a lubricant supply line by way of which the former are supplied with the lubricant. The lubricant supply line comprises a central supply duct 17 which extends in the longitudinal direction of the sealing strip 1 and from which a plurality of riser lines 18 which are disposed behind one another in the longitudinal direction L and which end in the base of the respective lubricant channel 9, 15, emanate.

The aforementioned explanations apply in equal measure to the second peripheral region not illustrated and to the further portion not illustrated of the central region 8 of the sealing strip 1.

FIGS. 4 to 6 show a second embodiment of a sealing strip 1 of a sealing device according to the invention which comprises the sealing strip 1 and a format limiter 2, in a plan view (FIG. 4), and in FIGS. 5 and 6, the sealing strip 1 interacting with a perforated roller sleeve rotating in the rotation direction D, in two sectional planes A-A and B-B which extend perpendicularly to the longitudinal direction L of the sealing strip.

In the following reference is to be made only to the differences in relation to the sealing strip 1 which is shown in FIGS. 1 to 3. The same technical components or features are provided with the same reference signs; different technical components or features are provided with different reference signs.

According to the invention, the sealing strip 1 in the peripheral region 7 has a plurality of lubricant opening of the third type which in the longitudinal direction are disposed behind one another and which are open toward the upper side 5 and toward the front end side 4 against which the format limiter 2 with its end side is placed. According to the invention, the extent of the lubricant opening of the third type 19 toward the front end side 4, when viewed in the longitudinal direction L of the sealing strip 1, is the same as or smaller than the extent of the format limiter 2. Adjacent lubricant openings of the third type 19 are in each case separated from one another in the longitudinal direction 20 by a portion 20 without a lubricant opening. The arrangement of lubricant openings of the third type 19 and portions 20 without lubricant openings extends in the longitudinal direction L of the sealing strip 1, specifically substantially across the entire length of the peripheral portion 7. As can be derived from FIG. 5, the lubricant openings of the third type 19 in the direction of the width B extend between the front end side 4 and the sealing face 6.

It is to be noted that the first lubricant channel 9 in the longitudinal direction L of the sealing strip 1 has a larger extent than the lubricant openings of the third type 19.

A small portion 16 in which no lubricant opening runs is disposed between the first lubricant channel 9 and the lubricant openings of the third type 19, when viewed in the longitudinal direction L of the sealing strip 1. As can be further derived from the illustration of FIG. 5, the lubricant opening of the third type 19 in the shown sectional plane has a base 21 and a front side wall 22 and a rear side wall 23, wherein the front side wall 22 extends from the base 21 to the front end side 4, and the rear side wall 23 extends from the base 21 to the sealing face 6 of the sealing strip 1, and wherein the front end side 4 and the front side wall 21, when viewed in the direction of the height H of the sealing strip 1, do not extend up to the sealing face 6 of the sealing strip 1. On account thereof, in the case of the installation of the sealing device into the roller according to the intended use a gap is formed between the front end side 4 and the inner side 13 of a roller sleeve 14, which gap tapers off toward the sealing face 6.

FIGS. 7 to 9 show a third embodiment of a sealing strip 1 of a sealing device according to the invention, comprising the sealing strip 1 and a format limiter 2, in a plan view (FIG. 7), and in FIGS. 8 and 9, the sealing strip 1 interacting with a perforated roller sleeve rotating in the rotation direction D, in two sectional planes A-A and B-B which extend perpendicularly to the longitudinal direction L of the sealing strip.

In the following reference is to be made only to the differences in relation to the sealing strip 1 which is shown in FIGS. 1 to 3. The same technical components or features are provided with the same reference signs; different technical components or features are provided with different reference signs.

According to the invention, the sealing strip 1 in the peripheral region 7 has no lubricant opening.

In the case of all shown lubricant openings of the first and/or third type, the rear side wall encloses an angle of 1° to 89°, in particular 15° to 75°, with a horizontal.

FIGS. 10 and 11 show a roller according to the invention, for a machine for manufacturing or processing a fibrous web, having a sealing device according to the invention, having two sealing strips according to the first embodiment as shown in FIGS. 1 to 3, in the sectional plane B-B (FIG. 10) and A-A (FIG. 11).

The roller has a perforated roller sleeve 14 which is movable in the rotation direction D and a positive-pressure or negative-pressure zone 24 which is disposed within the roller sleeve 14 and is rotationally fixed in comparison with the roller sleeve, and which in relation to the environment is sealed by means of a sealing device having two sealing strips as described in FIGS. 1 to 3, at the front side and rear side and, in each peripheral region, by means of a format limiter 2 as described in FIGS. 1 to 3. Thus, when viewed in the rotation direction D of the roller sleeve, the sealing device has a front sealing strip 1a, which is disposed ahead of the positive-pressure or negative-pressure zone 24, and a rear sealing strip 1b, which is disposed behind the positive-pressure or negative-pressure zone 24, and in each peripheral region 7 a format limiter 2, which extends between the front and rear sealing strips 1a, 1b. Presently, the front and the rear sealing strip 1a, 1b are identically configured. It can be derived from the illustration of FIG. 11, which depicts the sectional plane A-A in the peripheral region of the sealing strip, that the format limiter 2 has a sealing face 25 and a front end side 26 which is placed against the rear end side 3 of the front sealing strip 1a, and furthermore a rear end side 27 which is placed against the front end side 4 of the rear sealing strip 1b. Furthermore, the sealing faces 6 of the sealing strips 1a, 1b, and the sealing face 25 of the format limiter 2 are placed against the inner side 13 of the roller sleeve 14.

In the case of all shown exemplary embodiments, the roller sleeve 14, while turning, at the front end side 4 runs onto the respective sealing strip 1, 1a, 1b, and at the rear end side 3 runs off said sealing strip 1, 1a, 1 b again.

FIG. 12 shows a fourth embodiment of a sealing strip of a sealing device according to the invention, in a plan view, which corresponds to the sealing strip 1 shown in FIGS. 1 to 3 and differs therefrom only in that a connection channel 28, which runs substantially in the direction of the width B of the sealing strip 1, extends between the lubricant channel of the first type 9 and the lubricant channel of the second type 15.

1-15. (canceled)

16. A sealing device for sealing a pressure or vacuum zone in a roller having a perforated roller sleeve which is rotatable relative to the sealing device, the sealing device comprising:
at least one sealing strip for sealing a front-side or a rear-side of the pressure or vacuum zone, as viewed in a rotation direction of the roller;
said at least one sealing strip having front end and rear end sides delimiting a width of said sealing strip, and having upper and lower sides, wherein said upper side provides a sealing face;
said at least one sealing strip, as viewed in a longitudinal direction thereof, having two peripheral regions and a central region disposed therebetween;
said at least one sealing strip having at least one lubricant opening of a first type formed in said central region, said at least one lubricant opening of the first type being a depression in a material of said sealing strip and being open at least toward said upper side;
at least one format limiter for sealing a lateral edge of the pressure or vacuum zone, as viewed in a longitudinal direction of the roller and of said at least one sealing strip, said at least one format limiter being disposed so as to be level with one of said two peripheral regions, a viewed in the longitudinal direction of said sealing strip, said at least one format limiter having a sealing face and an end side, wherein said end side of said format limiter is placed against an end side of said sealing strip that faces toward the pressure or vacuum zone;
wherein, upon installation of the sealing device in the roller, said sealing face of said sealing strip and said format limiter are placed against the inner side of the roller sleeve, and upon rotation of the roller, the roller sleeve runs onto said sealing strip at said front end side thereof, and runs off said sealing strip at said rear end side thereof; and
said sealing strip at least in the peripheral region in which the end side of the format limiter is placed against the end side of said sealing strip, and one or more of the following is true:
i) said sealing strip is formed with at least one lubricant opening of a second type which is open toward said upper side, but which is not open toward said end side of said sealing strip against which the end side of said format limiter is placed; and/or
ii) said sealing strip is formed with at least one lubricant opening of a third type which is open toward said upper side and which is additionally open toward that end side of said sealing strip against which the end side of said format limiter is placed, wherein an extent of said lubricant opening of the third type, a viewed in the longitudinal direction of said sealing strip, is equal to or smaller than the extent of said format limiter; and/or
iii) no lubricant opening is formed at least in portions of said sealing strip.

17. The sealing device according to claim 16, wherein said at least one format limiter in said at least one peripheral region is displaceable, at least in portions, in the longitudinal direction of said sealing strip.

18. The sealing device according to claim 16, which comprises, as viewed in the rotation direction of the roller, a front sealing strip disposed ahead of said pressure or vacuum zone, and a rear sealing strip disposed behind the pressure or vacuum zone, wherein said format limiter extends between said front and rear sealing strips, wherein at least said rearward sealing strip is a sealing strip having in a central region at least one lubricant opening of the first type and in the peripheral region either no lubricant opening or a lubricant opening of the second and/or third type.

19. The sealing device according to claim 16, wherein the upper side is formed by the sealing face.

20. The sealing device according to claim 16, wherein said lubricant opening of the second type and/or of the third type, as viewed in a direction of a width of said sealing strip, extends between a front portion of the sealing face that adjoins the front end side and a rear portion of the sealing face that adjoins the rear end side.

21. The sealing device according to claim 16, wherein said lubricant opening of the third type, as viewed in a direction of a width of said sealing strip, extends between the front end side and the sealing face.

22. The sealing device according to claim 16, wherein said format limiter in the peripheral region is displaceable at least in portions in the longitudinal direction of the roller.

23. The sealing device according to claim 16, wherein said lubricant opening of the first type, as viewed in a direction of a width of said sealing strip, is disposed between the sealing face and the front end side and is open toward the front end side.

24. The sealing device according to claim 16, wherein said lubricant opening of the first type and/or of the second type and/or of the third type is configured as a lubricant channel formed of a groove-shaped depression in the material of said sealing strip and extends substantially in the longitudinal direction of said sealing strip.

25. The sealing device according to claim 16, wherein said lubricant opening of the first type is a lubricant channel, and said lubricant channel, as viewed in the longitudinal direction of said sealing strip, has a greater extent than the lubricant opening of the second and/or third types.

26. The sealing device according to claim 25, wherein said lubricant openings of the second and third types are formed as lubricant channels.

27. The sealing device according to claim 16, wherein said lubricant opening of the first type and/or third type, a viewed in a plane perpendicular to the longitudinal direction of said sealing strip, has a base and a front side wall and a rear side wall, wherein said front side wall extends from said base to a front end side, and said rear side wall extends from said base to the sealing face of said sealing strip, and wherein the front end side and said front side wall, as viewed in the direction of the height of said sealing strip, do not extend up to the sealing face of said sealing strip.

28. The sealing device according to claim 27, wherein said rear side wall encloses an angle of 1° to 89° with a horizontal.

29. The sealing device according to claim 28, wherein the angle lies between 15° and 75° relative to the horizontal.

30. The sealing device according to claim 16, wherein, as viewed in the longitudinal direction of said sealing strip, a portion without a lubricant opening is disposed between a lubricant opening of the first type and of the second or third type.

31. The sealing device according to claim 16, wherein, as viewed in the longitudinal direction of said sealing strip, in each case one portion without a lubricant opening is disposed between successive lubricant openings of the third type.

32. A roller for a machine for manufacturing or processing a fibrous web, the roller comprising:
a movable perforated roller sleeve and a pressure or vacuum zone within said roller sleeve and rotationally fixed relative to said roller sleeve; and
a sealing device according to claim 16 disposed to seal the pressure or vacuum zone in relation to an environment.
